(19) United States
(12) Patent Application Publication
(10) Pub. No.: US 2014/0365287 A1
(43) Pub. Date: Dec. 11, 2014

(54) Loyalty Point Reward System

(71) Applicant: Maher Pedersoli, Tucson, AZ (US)

(72) Inventor: Maher Pedersoli, Tucson, AZ (US)

(21) Appl. No.: 13/912,111

(22) Filed: Jun. 6, 2013

(51) Int. Cl. G06Q 30/02

(52) U.S. Cl. CPC G06Q 30/0226
USPC 705/14.25

(57) ABSTRACT

A method to configure a loyalty points reward program, where the method configures a loyalty program server comprising computer readable program code to configure a loyalty point merchant consortium and a loyalty point customer consortium comprising a plurality of participating consumers. The method further dynamically sets a universal loyalty point value, and determines a quantity of universal loyalty points to allocate to the first customer based upon prior purchases made by the first consumer from the plurality of participating merchants.

### FIELD OF THE INVENTION

The present application relates generally to an improved data processing apparatus and method and more specifically to mechanisms for universal online loyalty reward program.

### BACKGROUND OF THE INVENTION

Loyalty programs are common marketing efforts that reward loyal buying behavior that is potentially of benefit to a business. Frequent flyer programs are examples of well known loyalty programs. In most cases, loyalty points gained from one business cannot be converted to loyalty points of different businesses. One may use loyalty points to purchase from a restricted set of loyalty partners that are part of a loyalty agreement between a business and its loyalty partners.

If a customer does not have the required amount of loyalty points for a particular reward at a given time, then the points have no value to the customer at that time. In fact, a customer may have points in several loyalty programs at the same time; however, the customer may not have enough points to redeem for a desired reward in any one loyalty program. Thus, the customer may have unusable points in several loyalty programs, even though the loyalty programs may share common loyalty partners or may have different loyalty partners offering similar rewards.

For example, a customer may have a first number of points in a loyalty program for an electronics retailer, a second number of points in a loyalty program for a soft drink, a third number of points in a loyalty program for a sandwich shop, a fourth number of points in a loyalty program for a clothing store, a fifth number of points in a loyalty program for an athletic shoe retailer, a sixth number of points in a loyalty program for a book store, and a seventh number of points in a loyalty program for a coffee shop. It is not uncommon for a customer to have a modest number of points in each of a plurality of loyalty programs. The customer may be very loyal to every one of the vendors or service providers, but the rewards that are attainable for the points in each separate loyalty program may be underwhelming.

As a result of the above disadvantages, loyalty programs are seen by many customers as a nuisance. The low level rewards are not worth the time and effort to manage multiple loyalty programs. The high level rewards appear unattainable. With no easy and practical way to offer universal loyalty points by different merchants of different product and services offering, loyal buying behavior goes unrewarded, and the customers are not encouraged to repeat this behavior.

### SUMMARY OF THE INVENTION

Applicant's loyalty point reward system comprises a program which includes participating merchants and participating customers. A participating customer accrues both local loyalty points and universal loyalty points based upon prior purchases from participating merchants.

Each participating merchants allocates a certain number of local loyalty points to participating customers based upon those costumers' prior purchase from that specific merchant. Applicant's loyalty point rewards system allocates universal loyalty points to a customer based upon that customer's aggregate purchases from all the participating merchants. A participating customer may partially or completely offset the price of a good or service sold by a first merchant using first merchant local loyalty points and/or universal loyalty points.

A mechanism is provided for offering a universal loyalty program by a network of merchants. The mechanism forms a coalition of a plurality of merchants in a plurality of merchants who sell the same or different products or services. Each merchant within the plurality of merchants participate in the same loyalty program. Each merchant within the plurality of merchants offers products, services or both to plurality of customers participating in the same loyalty program. Each reward offered by a merchant to plurality of customers is offered for a balance of local loyalty points (merchant's specific points) or universal loyalty points or a combination of local and universal points.

A plurality of customers can earn local loyalty points or universal loyalty points or both at plurality of participating merchants by visiting merchant location or purchasing products or services at merchant location or merchant online store. Each merchant within the plurality of merchants requests to calculate total universal and local loyalty points for a reward by submitting a dollar value of the offered reward in a loyalty program. The mechanism further calculates the optimal dollar value of a universal loyalty point among the plurality of merchants. The dollar value of a universal loyalty points will be known as the Universal Point Value (UPv). The dollar value of a local loyalty points will be known as the Local Point Value (LPv).

In certain embodiments, if the consumer elects to redeem to awarded local loyalty point in combination with the awarded universal loyalty points when the offer is made by the merchant, then the combined monetary value of the local loyalty points and universal loyalty points may be sufficient to cover the entire cost of the good or service offered. If the combined monetary value of the local loyalty points and universal loyalty points is not sufficient to cover the entire cost of the good or service offered, then the customer may pay the remaining portion of the sales price using cash or credit.

If the user does not purchase the proffered good or service on the day the merchant makes an offer of local loyalty points and/or universal loyalty points, but rat the customer returns to the merchant the next day to make a purchase, the value of the awarded local loyalty points and/or universal loyalty points may be different from the value determined the previous day. In certain embodiments, the UPv may be greater on the second day than the UPv was on the first day. In certain embodiments, the UPv may be less on the second day than the UPv was on the first day. In certain embodiments, the LPv may be greater on the second day than the UPv was on the first day. In certain embodiments, the LPv may be less on the second day than the UPv was on the first day.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates an embodiment of Applicant's loyalty point rewards system;

FIG. 2 illustrates various modules comprising computer readable program code which when performed by a programmable computer processor implements Applicant's loyalty points reward method;

FIG. 3A summarizes certain steps in Applicant's loyalty points reward method;

FIG. 3B summarizes certain additional steps in Applicant's loyalty points reward method;

FIG. 4 summarizes certain additional steps in Applicant's loyalty points reward method; and

FIG. 5 summarizes certain additional steps in Applicant's loyalty points reward method.

### DETAILED DESCRIPTION OF PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

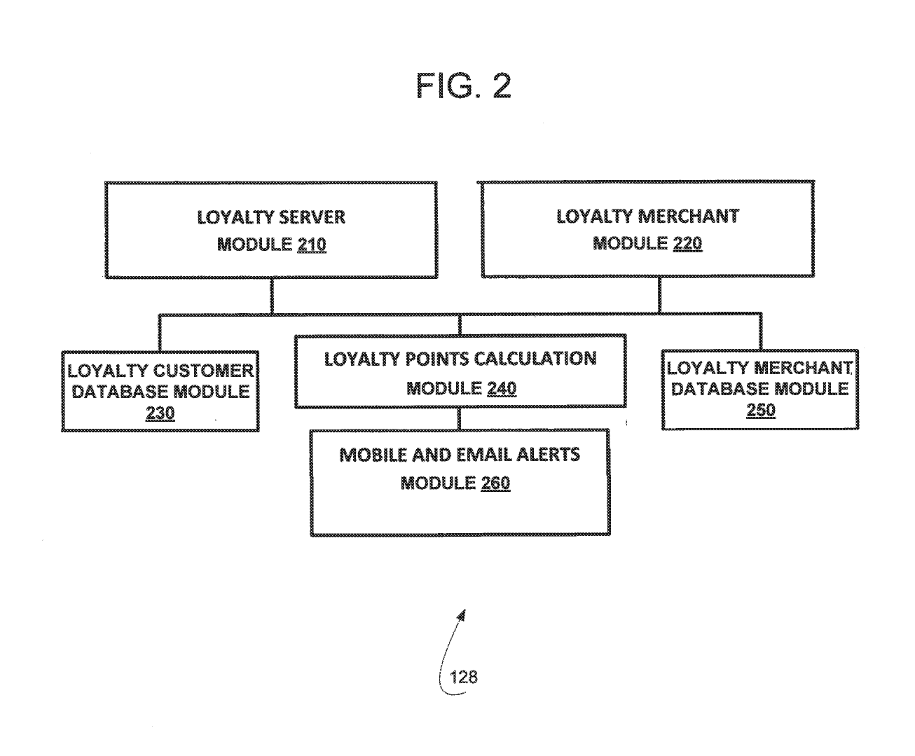

Many of the functional units described in this specification have been labeled as modules (e.g., modules 210, 220, 230, 240, 250, 260, FIG. 2) in order to more particularly emphasize their implementation independence. For example, a module (e.g., modules 210, 220, 230, 240, 250, 260, FIG. 2) may be implemented as a hardware circuit comprising custom VLSI circuits or gate arrays, off-the-shelf semiconductors such as logic chips, transistors, or other discrete components. A module (e.g., modules 210, 220, 230, 240, 250, 260, FIG. 2) may also be implemented in programmable hardware devices such as field programmable gate arrays, programmable array logic, programmable logic devices, or the like.

Modules (e.g., modules 210, 220, 230, 240, 250, 260, FIG. 2) may also be implemented in software for execution by various types of processors. An identified module of executable code may, for instance, comprise one or more physical or logical blocks of computer instructions which may, for instance, be organized as an object, procedure, or function. Nevertheless, the executables of an identified module (e.g., modules 210, 220, 230, 240, 250, 260, FIG. 2) need not be physically collocated, but may comprise disparate instructions stored in different locations which, when joined logically together, comprise the module and achieve the stated purpose for the module.

Indeed, a module of executable code (e.g., modules 210, 220, 230, 240, 250, 260, FIG. 2) may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

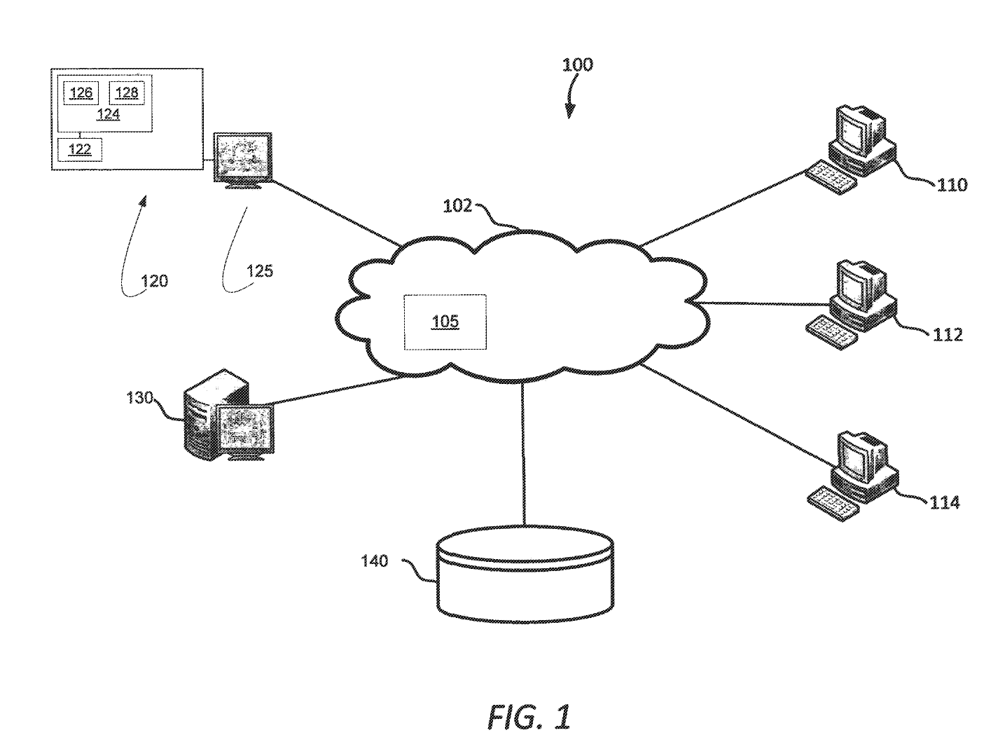

Referring now to FIG. 1, Applicant's system 100 comprises a plurality of merchant computing devices, shown in FIG. 1 as computing devices 110, 112, and 114, a loyalty points server 120, a network attached storage (“NAS”) controller 130, and a non-transitory computer readable medium 140. In certain embodiments, NAS controller 130 is integral with loyalty points server 120.

In the illustrated embodiment of FIG. 1, merchant computing devices 110, 112, and 113, are in communication with loyalty points server 120, NAS controller 130, and computer readable medium 140 via a communication fabric 102. As illustrated in FIG. 1, communication fabric 102 comprises one or more switches 105. In certain embodiments, communication fabric 102 comprises the Internet, an intranet, an extranet, a storage area network (SAN), a wide area network (WAN), a local area network (LAN), a virtual private network, a satellite communications network, an interactive television network, or any combination of the foregoing. In certain embodiments, communication fabric 102 utilizes either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 120 and 140 utilize any of a variety of communication protocols, such as Transmission Control Protocol/Internet Protocol (TCP/IP), for example.

In certain embodiments, loyalty points server comprises processor 122 and a non-transitory computer readable medium 124. In certain embodiments, loyalty points server 120 further comprises an operating system 126 and computer readable program code 128 encoded in the computer readable medium 124. Processor 122 utilizes operating system 126 to operate loyalty points server 120. Processor 122 utilizes computer readable program code 128 to implement Applicant's loyalty points method.

In certain embodiments, merchant computing device 112 is owned and/or operated by a first merchant selling a first kind of goods and/or services in commerce. In certain embodiments, the first merchant owns and/or operates a single retail sales establishment. In certain embodiments, the first merchant operates a plurality of retail sales establishments in a same city or geographical location, such as and without limitation New York City, Clark County Nevada, the bay area of Northern California, and the like. In certain embodiments, the first merchant operates a plurality of retail sales establishments in a plurality of states within the United States. In certain embodiments, the first merchant operates a plurality of retail establishments throughout the world.

In certain embodiments, the second merchant owns and/or operates a single retail sales establishment. In certain embodiments, the second merchant operates a plurality of retail sales establishments in a same city or geographical location, such as and without limitation New York City, Clark County Nevada, the bay area of Northern California, and the like. In certain embodiments, the second merchant operates a plurality of retail sales establishments in a plurality of states within the United States. In certain embodiments, the second merchant operates a plurality of retail establishments throughout the world.

In certain embodiments, the third merchant owns and/or operates a single retail sales establishment. In certain embodiments, the third merchant operates a plurality of retail sales establishments in a same city or geographical location, such as and without limitation New York City, Clark County Nevada, the bay area of Northern California, and the like. In certain embodiments, the third merchant operates a plurality of retail sales establishments in a plurality of states within the United States. In certain embodiments, the third merchant operates a plurality of retail establishments throughout the world.

In certain embodiments, the first merchant sells in commerce goods which fall under, for example and without limitation: Division G of the OSHA Standard Industrial Codes entitled “Retail Trade,” including goods covered by Major Group 52 Building Materials, Hardware, Garden Supply, And Mobile Home Dealers, Major Group 53: General Merchandise Stores, Major Group 54: Food Stores, Major Group 55: Automotive Dealers And Gasoline Service Stations, Major Group 56: Apparel And Accessory Stores, Major Group 57: Home Furniture, Furnishings, And Equipment Stores, Major Group 58: Eating And Drinking Places, Major Group 59: Miscellaneous Retail Establishments. In certain embodiments, the first merchant sells in commerce services which fall under, for example and without limitation: Division H of the OSHA Standard Industrial Codes entitled Finance, Insurance and Real Estate,” including services covered by Major Group 60: Depository Institutions, Major Group 61: Non-depository Credit Institutions, Major Group 62: Security And Commodity Brokers, Dealers, Exchanges, And Services, Major Group 63: Insurance Carriers, Major Group 64: Insurance Agents, Brokers, And Service, Major Group 65: Real Estate, Major Group 67: Holding And Other Investment Offices. In certain embodiments, the first merchant sells in commerce services which fall under, for example and without limitation: Division I of the OSHA Standard Industrial Codes entitled Services, including for example and without limitation Major Group 70: Hotels, Rooming Houses, Camps, And Other Lodging Places, Major Group 72: Personal Services, Major Group 73: Business Services, Major Group 75: Automotive Repair, Services, And Parking, Major Group 76: Miscellaneous Repair Services, Major Group 78: Motion Pictures, Major Group 79: Amusement And Recreation Services, Major Group 80: Health Services, Major Group 81: Legal Services, Major Group 82: Educational Services, Major Group 83: Social Services, Major Group 84: Museums, Art Galleries, And Botanical And Zoological Gardens, Major Group 86: Membership Organizations, Major Group 87: Engineering, Accounting, Research, Management, And Related Services, Major Group 88: Private Households, and Major Group 89: Miscellaneous Services.

In certain embodiments, the second merchant sells in commerce goods which fall under, for example and without limitation: Division G entitled “Retail Trade,” including goods covered by Major Group 52 Building Materials, Hardware, Garden Supply, And Mobile Home Dealers, Major Group 53: General Merchandise Stores, Major Group 54: Food Stores, Major Group 55: Automotive Dealers And Gasoline Service Stations, Major Group 56: Apparel And Accessory Stores, Major Group 57: Home Furniture, Furnishings, And Equipment Stores, Major Group 58: Eating And Drinking Places, Major Group 59: Miscellaneous Retail Establishments. In certain embodiments, the second merchant sells in commerce services which fall under, for example and without limitation: Division H of the OSHA Standard Industrial Codes entitled Finance, Insurance and Real Estate,” including services covered by Major Group 60: Depository Institutions, Major Group 61: Non-depository Credit Institutions, Major Group 62: Security And Commodity Brokers, Dealers, Exchanges, And Services, Major Group 63: Insurance Carriers, Major Group 64: Insurance Agents, Brokers, And Service, Major Group 65: Real Estate, Major Group 67: Holding And Other Investment Offices. In certain embodiments, the second merchant sells in commerce services which fall under, for example and without limitation: Division I of the OSHA Standard Industrial Codes entitled Services, including for example and without limitation Major Group 70: Hotels, Rooming Houses, Camps, And Other Lodging Places, Major Group 72: Personal Services, Major Group 73: Business Services, Major Group 75: Automotive Repair, Services, And Parking, Major Group 76: Miscellaneous Repair Services, Major Group 78: Motion Pictures, Major Group 79: Amusement And Recreation Services, Major Group 80: Health Services, Major Group 81: Legal Services, Major Group 82: Educational Services, Major Group 83: Social Services, Major Group 84: Museums, Art Galleries, And Botanical And Zoological Gardens, Major Group 86: Membership Organizations, Major Group 87: Engineering, Accounting, Research, Management, And Related Services, Major Group 88: Private Households, and Major Group 89: Miscellaneous Services.

In certain embodiments, the third merchant sells in commerce goods which fall under, for example and without limitation: Division G entitled “Retail Trade,” including goods covered by Major Group 52 Building Materials, Hardware, Garden Supply, And Mobile Home Dealers, Major Group 53: General Merchandise Stores, Major Group 54: Food Stores, Major Group 55: Automotive Dealers And Gasoline Service Stations, Major Group 56: Apparel And Accessory Stores, Major Group 57: Home Furniture, Furnishings, And Equipment Stores, Major Group 58: Eating And Drinking Places, Major Group 59: Miscellaneous Retail Establishments. In certain embodiments, the third merchant sells in commerce services which fall under, for example and without limitation: Division H of the OSHA Standard Industrial Codes entitled Finance, Insurance and Real Estate,” including services covered by Major Group 60: Depository Institutions, Major Group 61: Non-depository Credit Institutions, Major Group 62: Security And Commodity Brokers, Dealers, Exchanges, And Services, Major Group 63: Insurance Carriers, Major Group 64: Insurance Agents, Brokers, And Service, Major Group 65: Real Estate, Major Group 67: Holding And Other Investment Offices. In certain embodiments, the third merchant sells in commerce services which fall under, for example and without limitation: Division I of the OSHA Standard Industrial Codes entitled Services, including for example and without limitation Major Group 70: Hotels, Rooming Houses, Camps, And Other Lodging Places, Major Group 72: Personal Services, Major Group 73: Business Services, Major Group 75: Automotive Repair, Services, And Parking, Major Group 76: Miscellaneous Repair Services, Major Group 78: Motion Pictures, Major Group 79: Amusement And Recreation Services, Major Group 80: Health Services, Major Group 81: Legal Services, Major Group 82: Educational Services, Major Group 83: Social Services, Major Group 84: Museums, Art Galleries, And Botanical And Zoological Gardens, Major Group 86: Membership Organizations, Major Group 87: Engineering, Accounting, Research, Management, And Related Services, Major Group 88: Private Households, and Major Group 89: Miscellaneous Services.

Referring now to FIG. 2, in certain embodiments computer readable program code 128 comprises a loyalty server module 210, a loyalty merchant module 220, a loyalty program module 230, a loyalty points calculation module 240, a loyalty merchant module 250, and a mobile and email alerts module 260.

Applicant method utilizes Applicant's system 100 to form a consortium of merchants who sell the same or different products or services. Each merchant participates in the same loyalty program. Each merchant offers products, services or both to plurality of customers participating in that loyalty program. Each reward offered by a merchant to plurality of customers is offered for a balance of universal loyalty points or local loyalty points or both.

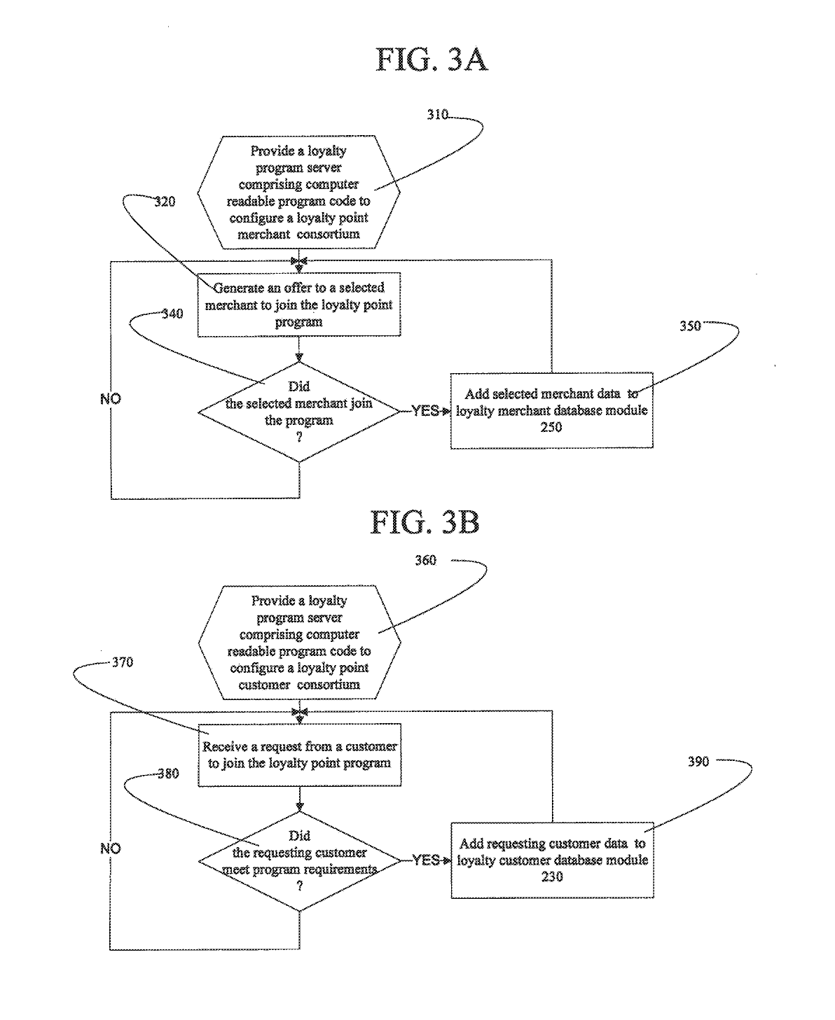

Referring now to FIG. 3A, in step 310 the method provides a loyalty program server comprising computer readable program code to configure a loyalty point merchant consortium. In certain embodiments, step 310 comprises utilizing Applicant's loyalty server 120 (FIG. 1). In step 320, the method generates an offer to a selected merchant to join the loyalty point program. In certain embodiments, step 320 is performed by Applicant's loyalty server 120. In certain embodiments, step 320 is performed by processor 122 utilizing module 220.

In step 340, the method determines if the selected merchant of step 320 accepted the offer to join the loyalty points program. In certain embodiments, step 340 is performed by Applicant's loyalty server 120. In certain embodiments, step 340 is performed by processor 122 utilizing module 220.

If the method determines in step 340 that the selected merchant of step 320 accepted the offer to join the loyalty points program, then the method transitions from step 340 to step 350 wherein the method adds selected merchant data to the loyalty merchant database module 350. In certain embodiments, step 350 is performed by Applicant's loyalty server 120. In certain embodiments, step 350 is performed by processor 122 utilizing module 220. In certain embodiments, the merchant data includes:

1. merchant unique id
2. merchant unique chain id
3. merchant geographical data
4. merchant category
5. merchant social profile
6. merchant private and public authentication keys
7. merchant reward profile
8. merchant reward policy
9. merchant geographical boundary settings
10. merchant group id
11. merchant transaction data
12. merchant to customer cross reference
13. merchant marketing campaign settings
14. merchant status code
15. merchant reward stats
16. merchant live analytics
17. merchant analytics
18. merchant transactional data
19. merchant rewards template code
20. merchant social campaign id
21. merchant social campaign policy
22. merchant social campaign template
23. merchant device id(s)
24. merchant device profile
25. merchant third party plugins

A plurality of customers can earn local loyalty points or universal loyalty points or both at plurality of participating merchants by visiting participating merchant locations, or purchasing products or services at participating merchant locations, or participating merchant online stores.

Referring now to FIG. 3B, in step 360 the method provides a loyalty program server comprising computer readable program code to configure a loyalty point customer consortium. In certain embodiments, step 360 comprises utilizing Applicant's loyalty server 120 (FIG. 1). In step 370, the method receives a request from a customer to join the loyalty point program. In certain embodiments, step 370 is performed by Applicant's loyalty server 120. In certain embodiments, step 370 is performed by processor 122 utilizing module 210.

In step 380, the method determines if the requesting customer meets the requirements of loyalty points program. In certain embodiments, step 380 is performed by Applicant's loyalty server 120. In certain embodiments, step 380 is performed by processor 122 utilizing module 210.

In certain embodiments, customer requirements include:

1. one account per customer (one time registration)
2. customer has a unique combination of id, email, and name
3. one customer's device per account
4. customer social links enable if applicable
5. customer geographical tracker enable if applicable
6. customer to track digital point records [local Points, Universal Point]
7. customer is able to make transaction at participant merchants
8. customer acceptance of terms and conditions.

If the method determines in step 380 that the requesting customer meets the requirements of loyalty points program, then the method transitions from step 380 to step 390 wherein the method adds the requesting customer data to the loyalty customer database module 230. In certain embodiments, step 390 is performed by Applicant's loyalty server 120. In certain embodiments, step 390 is performed by processor 122 utilizing module 210.

Each merchant within the plurality of selected merchants requests to calculate total points requirement including universal and/or local loyalty points for a reward by submitting the a dollar value of the reward in a loyalty program. The mechanism further calculate the optimal dollar value of a universal loyalty point among the plurality of merchants. The dollar value of a universal loyalty points will be known as the universal point value (UPv). The dollar value of a local loyalty points will be known as the local point value (LPv).

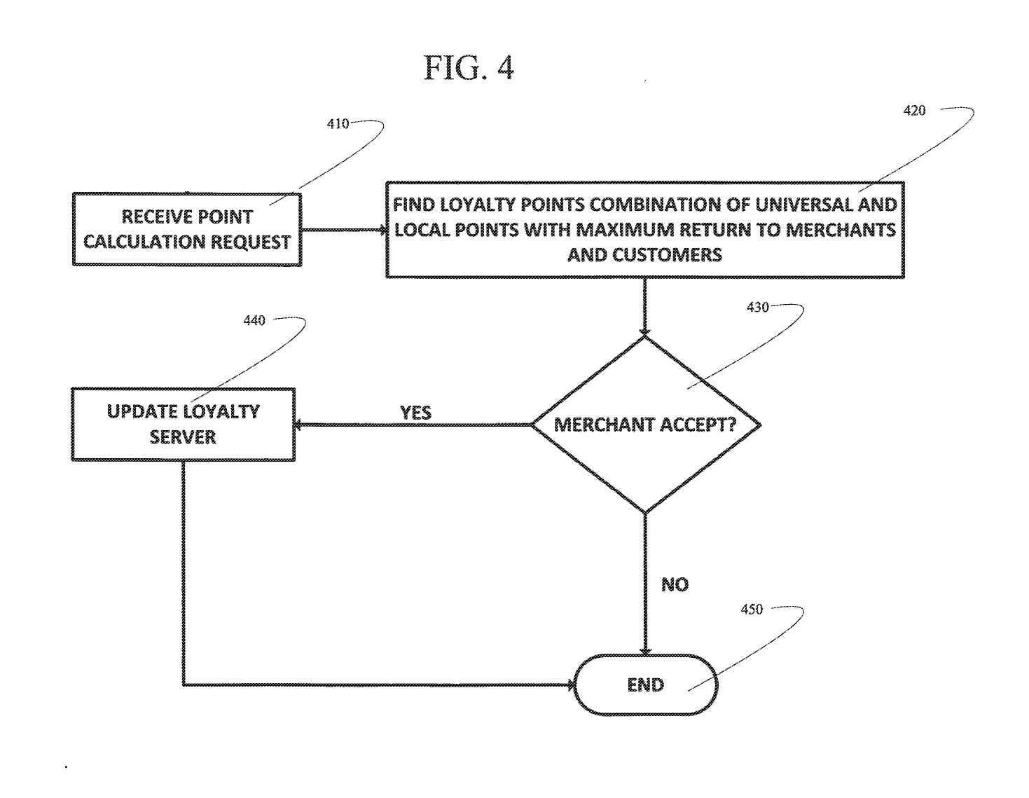

Referring now to FIG. 4, in step 410 the method receives a point calculation request from a participating merchant having data stored in Loyalty Merchant Database Module 250. In certain embodiments, step 410 is performed by Applicant's loyalty server 120. In certain embodiments, step 410 is performed by processor 122 utilizing module 220.

In step 420, the method determines a loyalty points combination of Universal Loyalty Points and Local Loyalty Points that generates a maximal return to both participating merchants and approved customers. In certain embodiments, step 420 is performed by Applicant's loyalty server 120. In certain embodiments, step 420 is performed by processor 122 utilizing module 240.

In step 430, the method determines if the participating merchant of step 410 accepts the loyalty point calculation of step 420. In certain embodiments, step 430 is performed by Applicant's loyalty server 120. In certain embodiments, step 430 is performed by processor 122 utilizing module 240.

If the participating merchant does not in step 430 accept the loyalty point calculation of step 420, then the method transitions from step 430 to step 450 and ends. In certain embodiments, step 450 is performed by Applicant's loyalty server 120. In certain embodiments, step 450 is performed by processor 122 utilizing module 240.

Alternatively, if the participating merchant does accept in step 430 the loyalty point calculation of step 420, then the method transitions from step 430 to step 440 wherein the method updates data in Loyalty Merchant Database Module 250 for the participating merchant. In certain embodiments, step 440 is performed by Applicant's loyalty server 120. In certain embodiments, step 440 is performed by processor 122 utilizing module 240. The method transitions from step 440 to step 450 and ends.

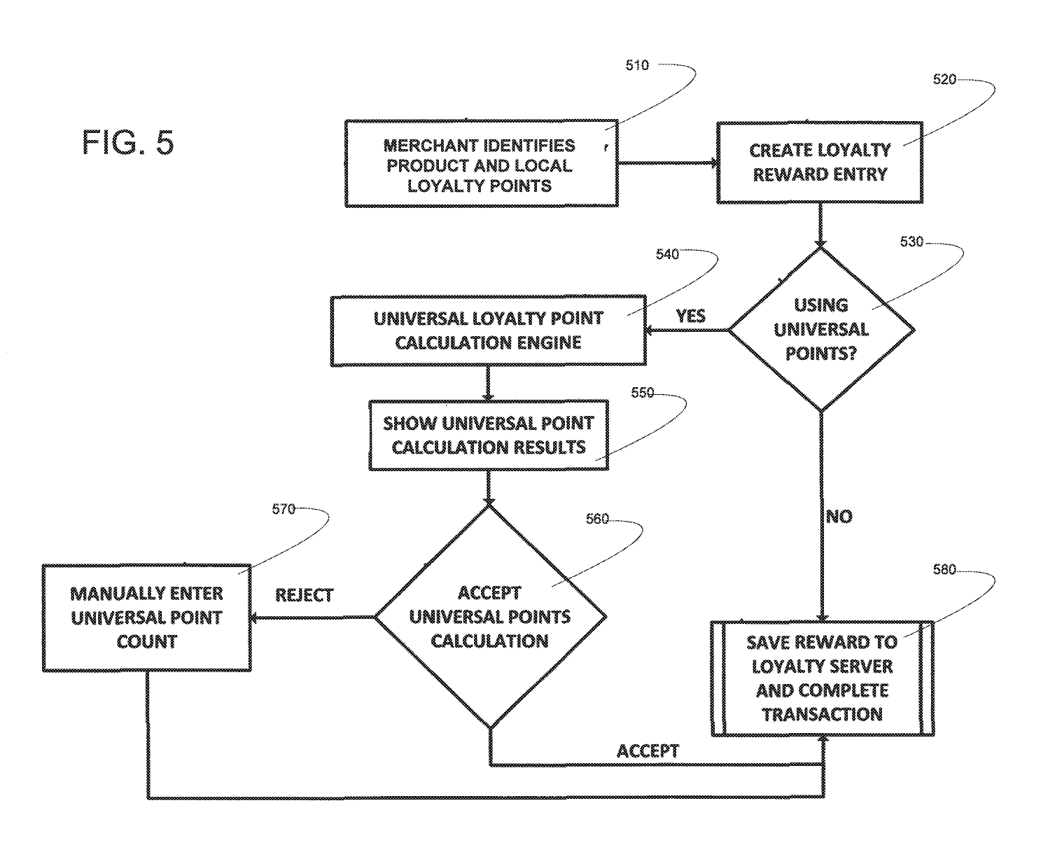

In certain embodiments, step 420 comprises the steps recited in FIG. 5. Referring now to FIG. 5, in step 510 the merchant defines a specific product or service and proposed Local Loyalty Points associated therewith. In certain embodiments, the data of step 510 is received by Applicant's Loyalty Points Server 120. In certain embodiments, the data of step 510 is provided to Loyalty Points Calculation Module 240. In certain embodiments, step 510 is performed by Applicant's loyalty server 120. In certain embodiments, step 510 is performed by processor 122 utilizing module 220.

In step 520, the method creates a Loyalty Reward Entry. In certain embodiments, step 520 is performed by Applicant's loyalty server 120. In certain embodiments, step 520 is performed by processor 122 utilizing module 240.

In step 530, the method determines whether the Loyalty Reward will utilize Universal Points. In certain embodiments, step 530 is performed by Applicant's loyalty server 120. In certain embodiments, step 510 is performed by processor 122 utilizing module 240.

If the method determines in step 530 that the Loyalty Reward of step 520 will include Universal Points, then the method transitions from step 530 to step 540 wherein Loyalty Points Calculation Module 240 calculates a number of proposed Universal Loyalty Points to be associated with the Loyalty Reward of step 520. In certain embodiments, step 540 is performed by Applicant's loyalty server 120. In certain embodiments, step 540 is performed by processor 122 utilizing module 240.

In certain embodiments, the Loyalty Points Calculation Module 240 is constantly receiving data from participating merchants. In these embodiments, the Loyalty Points Calculation Module 240 dynamically sets a value for Applicant's universal loyalty point. In certain embodiments, the value of a loyalty point is constantly changing.

In certain embodiments, the Loyalty Points Calculation Module 240 utilizes different input data to set the value of the system's universal loyalty points. A first aspect comprises a “supply side” analysis. For example, if the cost to the merchant of a particular good is high, then the system accommodates such a high supply side cost by setting a relatively low value for universal points used to redeem such a good.

The other aspect used by Loyalty Points Calculation Module 240 comprises a “demand side” analysis. For example, if the system wants to encourage customers to visit merchant establishments on a traditional “slow shopping day,” such as for example and without limitation Christmas day or Easter Sunday, then the system may set the value of universal points at a high value for that day only. Alternatively, on traditional “high shopping volume days,” such as without limitation Black Friday following Thanksgiving Day, the system may set the value of universal loyalty points at a low value for that day only.

In certain embodiments, Loyalty Points Calculation Module 240 bases the valuation of a loyalty point based upon customer trends. In these embodiments, if customer demand in a certain geographical area is traditional robust, i.e. high, for a specific good or service, then Loyalty Points Calculation Module 240 tends to assign a relatively low value of a loyalty point awarded to a customer in conjunction with the purchase of that specific good or service. Alternatively, if customer demand in a certain geographical area is traditional low for a specific good or service, then Loyalty Points Calculation Module 240 tends to assign a relatively high value of a loyalty point awarded to a customer in conjunction with the purchase of that specific good or service. In summary, the value of a universal loyalty point awarded in conjunction with the purchase of a specific good or service in a “high demand” geographical area is lower than the value for a universal loyalty point awarded in conjunction with the purchase of that same specific good or service in a “low demand” geographical area.

The following Examples are The following Examples are presented to further illustrate to persons skilled in the art how to make and use the invention. These Examples are not intended as a limitation, however, upon the scope of the invention.

### Example 1

This Example 1 is directed to setting a value of universal loyalty points awarded to a consumer in conjunction with renting the same automobile (same make, model, year, and appointments) for the same period of time and at the same hour of day on June 15 in either Phoenix, Ariz. or San Diego, Calif. In certain embodiments, Applicant's Loyalty Points Calculation Module 240 assigns a value of X US Dollars ($US X.00) for each universal loyalty point awarded to a consumer when renting the automobile in San Diego. In certain embodiments, Applicant's Loyalty Points Calculation Module 240 assigns a value of 2X US Dollars ($US 2X.00) for each universal loyalty point awarded to a consumer when renting the automobile in Phoenix.

### Example 2

This Example 2 is directed to setting a value of universal loyalty points awarded to a consumer in conjunction with renting the same automobile (same make, model, year, and appointments) for the same period of time and at the same hour of day on January 15 in either Phoenix, Ariz. or San Diego, Calif. In certain embodiments, Applicant's Loyalty Points Calculation Module 240 assigns a value of X US Dollars ($US X.00) for each universal loyalty point awarded to a consumer when renting the automobile Phoenix. In certain embodiments, Applicant's Loyalty Points Calculation Module 240 assigns a value of 2X US Dollars ($US 2X.00) for each universal loyalty point awarded to a consumer when renting the automobile in San Diego.

### Example 3

This Example 1 is directed to setting a value of universal loyalty points awarded to a consumer in conjunction with purchasing the same cellular telephone (same make, model, year, and appointments) on a Saturday from a specific merchant. In certain embodiments, Applicant's Loyalty Points Calculation Module 240 assigns a value of X US Dollars (SUS X.00) for each universal loyalty point awarded to a consumer purchasing the cellular telephone from that specific merchant. In certain embodiments, Applicant's Loyalty Points Calculation Module 240 assigns a value of 1.5X US Dollars (SUS 1.5X.00) for each universal loyalty point awarded to the same consumer when purchasing the same cellular telephone from the same merchant one day later on Sunday.

The dollar value of a local loyalty points will be known as the Local Point Value (LPv).

In certain embodiments, the dollar value of Universal Points (UPv) and Local Points (LPv) are driven by various factors such as:
1. The total dollar value of all goods and services redeemed for a balance of Universal Points in a geographical location during a given period by plurality of participating customers.
2. The total dollar value of all goods and services redeemed for a balance of Local Points in a geographical location during a given period by plurality of participating customers.
3. The total dollar value of all goods and services currently offered for a balance of Local Points in a geographical location during a given period by plurality of participating merchants.
4. The total dollar value of all goods and services currently offered for a balance of Universal Points in a geographical location during a given period by plurality of participating merchants.
5. The timely indicator of the plurality of the participating customers' spending patterns that is adjusted for seasonal variables.
6. Frequency/tendency to redeem those offers by the plurality of customers participating in the same loyalty program.
7. External factors like time of the year, holiday seasons, special events relative to a geographical location.

In certain embodiments, a geographical location is defined by a metropolitan area, such as and without limitation metro New York City area, metro Chicago area, and the like. In certain embodiments, a geographical area includes portions of a plurality of different states, such as and without limitation New York City, Northern new Jersey, and Southern Connecticut, and the “QUAD CITIES” (Davenport and Bettendorf in Iowa and Rock Island, Moline, and East Moline in Illinois.

In certain embodiments a geographical area includes the entirety of several states, such as and without limitation “DELMARVA,” meaning Delaware, Maryland, and Virginia. In certain embodiments, a geographical location is defined by a well-known portion of a state, such as and without limitation SOCAL (Southern California), Bay Area (San Francisco and surrounding counties).

In step 550, the method displays calculation results on an information display device in communication with the merchant computer operated by the participating merchant of step 510. In certain embodiments, step 550 is performed by Applicant's loyalty server 120. In certain embodiments, step 550 is performed by processor 122 utilizing module 240.

In step 560, the method determines if the merchant of step 510 accepts the proposed Universal Loyalty Points of step 540. In certain embodiments, step 560 is performed by Applicant's loyalty server 120. In certain embodiments, step 560 is performed by processor 122 utilizing module 240.

If the method determines in step 560 that the merchant of step 510 accepts the proposed Universal Point calculation of step 540, then the method transitions from step 560 to step 580 wherein the method saves in Loyalty Merchant Database Module 250 the Loyalty Reward comprising the merchant's proposed Local Loyalty Points in combination with the proposed Universal Loyalty Points of step 540. In certain embodiments, step 580 is performed by Applicant's loyalty server 120. In certain embodiments, step 580 is performed by processor 122 utilizing module 240.

Alternatively, if the method determines in step 560 that the merchant of step 510 does not accept the proposed Universal Point calculation of step 540, then the method transitions from step 560 to step 570 wherein the merchant of step 510 manually provides a Universal Loyalty Point count. In certain embodiments, the manually entered Universal Loyalty Point count of step 570 is received by Applicant's Loyalty Server 120. In certain embodiments, the manually entered Universal Loyalty Point count of step 570 is provided to Loyalty Points Calculation Module 240. The method transitions from step 570 to step 580.

In certain embodiments, Applicants' invention includes computer readable program code, such as computer readable program code 128, residing in a non-transitory computer readable medium, such as computer readable medium 124, where that computer readable program code is executed by a processor, such as processor 122, to perform one or more of steps 320, 340, and/or 350, recited in FIG. 3A, and/or one or more of steps 370, 380, and/or 390, recited in FIG. 3B, and/or one or more steps 410, 420, 430, 440, and/or 450, recited in FIG. 4, and/or one or more steps 510, 520, 530, 540, 550, 560, 570, and/or 580, recited in FIG. 5.

In other embodiments, Applicants' invention includes instructions residing in any other computer program product, where those instructions are executed by a computer external to, or internal to, system 100, to performs any of the steps 320, 340, and/or 350, recited in FIG. 3A, and/or one or more of steps 370, 380, and/or 390, recited in FIG. 3B, and/or one or more steps 410, 420, 430, 440, and/or 450, recited in FIG. 4, and/or one or more steps 510, 520, 530, 540, 550, 560, 570, and/or 580, recited in FIG. 5. In either case, the computer readable program code may be encoded in an non-transitory computer readable medium comprising, for example, a magnetic information storage medium, an optical information storage medium, an electronic information storage medium, and the like. By “electronic storage medium,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth herein.

I claim:

1. A method to configure a loyalty points reward program, comprising:
configuring a loyalty program server comprising computer readable program code to configure a loyalty point merchant consortium, wherein said loyalty point merchant consortium comprises a plurality of participating merchants selling goods and or services;
configuring said loyalty program server a loyalty point customer consortium comprising a plurality of participating consumers;
setting by a first merchant a first merchant local loyalty point dollar value, wherein said first merchant is one of said plurality of participating merchants;
determining by said first merchant a quality of said first merchant local loyalty points to allocate to a first consumer based upon prior purchases made by said first consumer from said first merchant, wherein said first consumer is one of said plurality of participating consumers;
dynamically setting by said loyalty program server a universal loyalty point value;
determining by said loyalty program server a quantity of said universal loyalty points to allocate to said first customer based upon prior purchases made by said first consumer from said plurality of participating merchants;
using by said first customer said allocated local loyalty points and said allocated universal loyalty points to purchase first goods and/or services from said first merchant.

2. The loyalty points reward program of claim 1, wherein each participating merchant sells in commerce goods and/or services described by Division G of the OSHA Standard Industrial Codes entitled Retail Trade, or by Division H of the OSHA Standard Industrial Codes entitled Finance, or by Division I of the OSHA Standard Industrial Codes entitled Services.

3. The loyalty points reward program of claim 1, wherein:
said first customer purchases said first goods and/or services from said first merchant in a first geographical location;
said loyalty program server sets said universal loyalty point value based upon said first geographical location.

4. The loyalty reward program of claim 1, wherein:
said first customer purchases said first goods and/or services from said first merchant on a first date;
said loyalty program server sets said universal loyalty point value based upon said first date.

5. The loyalty reward program of claim 4, wherein said loyalty program server sets said universal loyalty point value based upon said first geographical location and said first date.

6. The loyalty reward program of claim 1, wherein:
said first customer offers to purchase said first goods and/or services from said first merchant on a first date;
said loyalty program server sets a first universal loyalty point value based upon said first date;
said customer actually purchases said first goods and/or services from said first merchant on a second date, wherein said second date is one or more days later than said first date;
said loyalty program server sets a second universal loyalty point value based upon said second date, wherein said second universal loyalty point value is operative for said purchase on said second date, and wherein said second universal loyalty point value differs from said first universal loyalty point value.

7. The loyalty reward program of claim 1, wherein:
said first customer purchases said first goods and/or services from said first merchant in a first geographical location;
said first merchant sets said first merchant local loyalty point value based upon said first geographical location.

8. The loyalty reward program of claim 7, wherein:
said first customer purchases said first goods and/or services from said first merchant on a first date;
said first merchant sets said first merchant local loyalty point value based upon said first date.

9. The loyalty reward program of claim 8, wherein said first merchant sets said first merchant local loyalty point value based upon said first geographical location and said first date.

10. A loyalty program server comprising a non-transitory computer useable medium having computer readable program code encoded therein to configure a loyalty points reward program, the computer readable program code comprising a series of computer readable program steps to effect:
configuring a loyalty point merchant consortium comprising a plurality of participating merchants selling goods and or services;
configuring a loyalty point customer consortium comprising a plurality of participating consumers;
receiving from a first merchant a first merchant local loyalty point dollar value, wherein said first merchant is one of said plurality of participating merchants;
receiving from said first merchant a quality of said first merchant local loyalty points to allocate to a first consumer based upon prior purchases made by said first consumer from said first merchant, wherein said first consumer is one of said plurality of participating consumers;
dynamically setting a universal loyalty point value;
determining a quantity of said universal loyalty points to allocate to said first customer based upon prior purchases made by said first consumer from said plurality of participating merchants.

11. The loyalty program server of claim 10, wherein each participating merchant sells in commerce goods and/or services described by Division G of the OSHA Standard Industrial Codes entitled Retail Trade, or by Division H of the OSHA Standard Industrial Codes entitled Finance, or by Division I of the OSHA Standard Industrial Codes entitled Services.

12. The loyalty program server of claim 10, wherein said first customer purchases said first goods and/or services from said first merchant in a first geographical location, the computer readable program code further comprising a series of computer readable program steps to effect setting said universal loyalty point value based upon said first geographical location.

13. The loyalty program server of claim 10, wherein said first customer purchases said first goods and/or services from said first merchant on a first date, the computer readable program code comprising a series of computer readable program steps to effect setting said universal loyalty point value based upon said first date.

14. The loyalty program server of claim 13, the computer readable program code comprising a series of computer readable program steps to effect setting said universal loyalty point value based upon said first geographical location and said first date.

15. The loyalty program server of claim 10, wherein:
said first customer offers to purchase said first goods and/or services from said first merchant on a first date;
said loyalty program server sets a first universal loyalty point value based upon said first date;
said customer actually purchases said first goods and/or services from said first merchant on a second date, wherein said second date is one or more days later than said first date;
said loyalty program server sets a second universal loyalty point value based upon said second date, wherein said second universal loyalty point value is operative for said purchase on said second date, and wherein said second universal loyalty point value differs from said first universal loyalty point value.

16. A computer program product encoded in a non-transitory computer readable medium and usable with a programmable computer processor to configure a loyalty points reward program, comprising:
computer readable program code which causes said programmable computer processor to
computer readable program code which causes said programmable computer processor to configuring a loyalty point merchant consortium comprising a plurality of participating merchants selling goods and or services;
computer readable program code which causes said programmable computer processor to configuring a loyalty point customer consortium comprising a plurality of participating consumers;
computer readable program code which causes said programmable computer processor to receiving from a first merchant a first merchant local loyalty point dollar value, wherein said first merchant is one of said plurality of participating merchants;
computer readable program code which causes said programmable computer processor to receiving from said first merchant a quality of said first merchant local loyalty points to allocate to a first consumer based upon prior purchases made by said first consumer from said first merchant, wherein said first consumer is one of said plurality of participating consumers;
computer readable program code which causes said programmable computer processor to dynamically setting a universal loyalty point value;
computer readable program code which causes said programmable computer processor to determining a quantity of said universal loyalty points to allocate to said first customer based upon prior purchases made by said first consumer from said plurality of participating merchants.

17. The loyalty program server of claim 16, wherein each participating merchant sells in commerce goods and/or services described by Division G of the OSHA Standard Industrial Codes entitled Retail Trade, or by Division H of the OSHA Standard Industrial Codes entitled Finance, or by Division I of the OSHA Standard Industrial Codes entitled Services.

18. The loyalty program server of claim 16, wherein said first customer purchases said first goods and/or services from said first merchant in a first geographical location, further comprising computer readable program code which causes said programmable computer processor to set said universal loyalty point value based upon said first geographical location.

19. The loyalty program server of claim 16, wherein said first customer purchases said first goods and/or services from said first merchant on a first date, further comprising computer readable program code which causes said programmable computer processor to set said universal loyalty point value based upon said first date.

20. The loyalty program server of claim 19, further comprising computer readable program code which causes said programmable computer processor to set said universal loyalty point value based upon said first geographical location and said first date.

21. The loyalty program server of claim 10, wherein:
said first customer offers to purchase said first goods and/or services from said first merchant on a first date;
said customer actually purchases said first goods and/or services from said first merchant on a second date, wherein said second date is one or more days later than said first date;
further comprising:
computer readable program code which causes said programmable computer processor to set on said first date a first universal loyalty point value based upon said first date;
computer readable program code which causes said programmable computer processor to set on said second date a second universal loyalty point value based upon said second date, wherein said second universal loyalty point value is operative for said purchase on said second date, and wherein said second universal loyalty point value differs from said first universal loyalty point value.
